(19) United States
(12) Patent Application Publication
(10) Pub. No.: US 2018/0118550 A1
(43) Pub. Date: May 3, 2018

(54) Display Device

(71) Applicant: Dot Design Group Pty Limited, Kings Cross (AU)

(72) Inventors: Seunghyoun LEE, Kings Cross (AU); Leonard VELICH, Kings Cross (AU); Thomas RYAN, Kings Cross (AU)

(21) Appl. No.: 15/798,555

(22) Filed: Oct. 31, 2017

Related U.S. Application Data
(60) Provisional application No. 62/415,214, filed on Oct. 31, 2016.

(51) Int. Cl. B67D 1/08; B67D 1/00; G09F 23/06; G09F 7/22; G09F 23/02; G09F 9/00; G09F 11/10; G09F 13/00

(52) U.S. Cl. CPC B67D 1/0877; B67D 1/0086; G09F 23/06; G09F 7/22; G09F 2007/1856; G09F 9/00; G09F 11/10; G09F 13/00; G09F 23/02

(57) ABSTRACT

A display device attachment configured to mount on a bar gun is described. The display device comprises a mount; and a display element operatively mounted on the mount so as to move relative to the bar gun when the bar gun is handled to pour a drink. There is also described a bar gun with an integral or attached display device, the display device comprising: a display element operatively mounted on the bar gun so as to move when the bar gun is handled to pour a drink.

### TECHNICAL FIELD

The present invention relates generally to point of sale advertising and brand messaging devices. Although users of embodiments of the invention will find it particularly advantageous in nightclubs, it is to be understood that it will be equally useful in pubs, fast food venues, restaurants, bars and the like.

### BACKGROUND

In a busy nightclub environment, brands compete for attention. Advertising messages and devices are mounted on beer taps, on mirrors, walls, cans, bottles, fridges, bar mats and the like. All these messages make for a crowded point of sale area and it can be difficult for a brand to successfully stand out in a customer's mind. Indeed the effect is that the brands can all be washed out in the customer's mind so that none of them make any impact.

Compounding the problem is the phenomenon that, while at the bar, customers can also feel under pressure to make fast decisions.

In this busy environment, there is one area of substantially guaranteed customer focus: the bartender. Once their attention has been gained and an order placed, there is one further area of particular scrutiny, which is the amount of drink that is being poured into the glass by the bartender.

Brands can find it difficult to cut through to a customer during this transaction. The bar is often a place where a decision between one brand and another will be made and brand owners seek to increase brand awareness at this point of sale.

Accordingly, the present technology seeks to ameliorate one or more of the disadvantages present in the prior art, or seeks to provide another alternative to the prior art approaches. The present technology seeks to provide a new display device for use in a bar environment.

### SUMMARY OF THE INVENTION

Definitions: Throughout this specification and the claims that follow, a bar gun is to be understood to be a hand held dispenser of liquids, which can be carbonated or still. Usually the bar gun is connected to a plurality of tubing which is connected to reservoirs of liquids, and the bar gun is configured to select a reservoir and liquid to be dispensed from the bar gun by selection and actuation of a button.

Broadly, the present technology provides a brand message on or adjacent a bar gun.

Broadly, the present technology provides an animated brand message disposed near a bar gun.

Broadly, the present technology provides a display device attachment configured to mount an animated brand message on a bar gun.

According to one aspect of the present technology there is provided a display device attachment configured to mount on a bar gun, the display device comprising:

a mount; and

a display element operatively mounted on the mount so as to move relative to the bar gun when the bar gun is handled to pour a drink.

According to another aspect of the present technology there is provided a bar gun with an integral display device, the display device comprising:

a display element operatively mounted on the bar gun so as to move relative to the bar gun when the bar gun is handled to pour a drink.

According to yet another aspect of the present technology there is provided a bar gun with an attached display device, comprising a display element operatively mounted on the bar gun so as to move relative to the bar gun when the bar gun is handled to pour a drink.

According to still another aspect of the present technology there is provided a bar gun with an integral display device, which comprises a display element operatively mounted on the bar gun so as to move when the bar gun is handled to pour a drink.

In one embodiment the display element is operatively mounted on the mount or the bar gun so as to remain in substantially a vertical plane independent of an orientation of the bar gun, at least with respect to one axis.

In some embodiments the display element is operatively mounted so as to spin, swivel, sway, bounce, slide, flip, or otherwise move.

In some embodiments the display element is operatively mounted to move in response to the movement of the bar gun.

In some embodiments the display element is operatively mounted to move in response to the actuation of fluid flow in the bar gun. The response in some embodiments may be to moving fluid which will flow into a customer's glass, or a working fluid in a separate circuit, or an actuator circuit of hydraulic, working or electrical current.

Mount

In some embodiments the mount is a base for mounting onto the end of the bar gun.

In some embodiments the mount includes locators to locate the mount on a selected portion of the bar gun.

In some embodiments the locators are in the form of catches, flanges or other undulations to facilitate location and grip on the bar gun.

In some embodiments there are grip regions such as knurling or sawtooth elements provided to increase the surface area of a mounting surface for increased hold.

In some embodiments there is provided a fastener to fasten the mount to a portion of the bar gun.

In some embodiments the fastener comprises double-sided adhesive tape but it may equally well include a screw, adhesive fluid ie glue, one or more straps of adjustable length, hook and loop fastener elements, or other suitable ties.

Operative Connection

In some embodiments the operative connection between the mount and the display element provides one or more degrees of freedom of movement to the display element. In one embodiment the operative connection is a joint which provides those levels of freedom, of rotation or translation or both, for movement of the display element in response to the handling and/or operation of the bar gun.

In some embodiments the mount includes one or more holders for holding the display element sufficiently spaced from the bar gun to facilitate its movement in response to the handling or operation of the bar gun. Each holder may be a, or other holding element.

In some embodiments the one or more holders comprise a plurality of arms spaced apart from one another so as to provide a mounting zone therebetween for the display device.

In some embodiments the holders include receivers for receiving cooperating boss elements to be received therein. In some embodiments the receivers are bores for receiving stub axles extending from the display element so that the display element may rotate while mounted on the holder.

In some embodiments there may be a cross member or cantilevered member acting to hang the display element thereon.

In some embodiments the mount includes a receiver on the base, to mount a spring for mounting the display element thereon.

Display Element

In some embodiments the display element is a sign or board or like element on which a message may be printed.

In some embodiments the sign is in the form of a plate, disc, sphere, roller, or any suitable regular or irregular two-dimensional or three dimensional shape. For example the sign may be in the shape of an animal, animal head, stylised person, octagon, dodecahedron, pentagon, hexagon, building, wrecking ball, or suitable element for indicating a trade mark, brand message or other indicator.

In some embodiments the sign includes a power source so as to power onboard elements.

In some embodiments the power source is a battery for lighting the display element.

In some embodiments the sign includes a lenticular element to provide a movable image when there is relative movement between a viewer and the sign.

In some embodiments the display element may respond to a working fluid or a dispensed fluid from the bar gun itself in response to the actuation of the bar gun. In some embodiments the display element may further include a drive to respond to the working or dispensed fluids, and/or the sign itself may respond to the fluid. In these embodiments, the working fluid may be in a circuit to drive the drive, or in some embodiments the dispense fluid may exit a nozzle and impact the sign itself to drive the display element.

In some embodiments the display element may be a powered screen. In some embodiments the screen may be an LED, LCD, e-Ink, or other suitable screen.

The display element may include programmable or preprogrammed computing processor elements such as processor, memory, input devices, all connected by a bus, which are responsive to instructions so as to display different messages on the screen.

In some embodiments the display element may be an unpowered screen for receiving projected images or messages from a projector mounted on the bar gun or mount. For example there may be a heads up display.

In some embodiments there may be provided a projector on the bar gun or mount for projecting brand colours, messages or the like into an atomised mist or in a stream of dispensed fluid issuing from a nozzle of the bar gun.

A motor may be provided in the display element or in the mount holder for rotating or spinning or otherwise controlling the attitude of the display element.

In some embodiments the display element includes one or more extensions to mount in cooperating receivers on the mount so as to swing or rotate on the mount.

In some embodiments the display element is mounted on the mount so as to provide a damped or biased swinging movement wherein the display element seeks to hang in a substantially vertical position in response to movement of the mount/bar gun. In one embodiment to provide this motion the one or more extensions are offset from a centre of axis of the display element so as to provide the biased movement. The effect is similar to that provided by a weight in a lower portion of the display element, and that feature of the weight is contemplated by the present inventors as being within the scope of this invention. So it is to be understood that providing swinging about a centre (of area) of the display element, coupled with an offset mass distribution (to the base of the display element), would be useful with this invention and covered by its scope. It is this feature which is particularly advantageous in this invention since the brand message is presented substantially vertically to the customer while a drink is being poured. The other features of spinning, illumination, and so on are also advantageous for obtaining and keeping attention of the customer and directing their attention to the brand message on the display while in a crowded environment.

The display element may be an element which self-rights or otherwise moves in a vessel of fluid.

### BRIEF DESCRIPTION OF THE DRAWINGS

Preferred embodiments of the invention will now be described, by way of example only, with reference to the accompanying drawings in which:

FIG. 1 is an isometric view of a display device attachment for a bar gun;

FIG. 2 is an isometric view of the display device of FIG. 1 from behind;

FIGS. 3 and 4 show isometric views of the display device of FIG. 1 showing fastener options;

FIGS. 5 (A to H) show isometric views of mounting options for the display device—being on an end, back, or similar, and showing mounting arm options —being inclined from various axes;

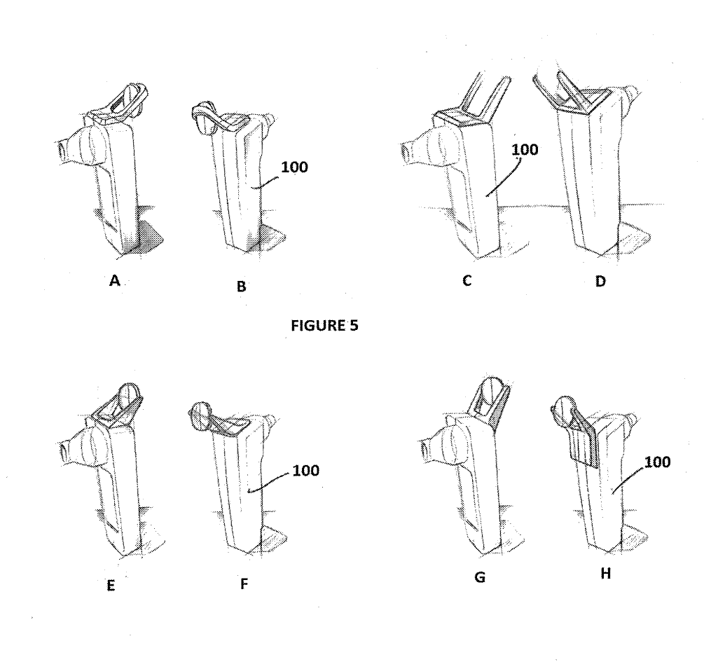

FIG. 6 shows a modification of the mount which includes a peripheral frame (including a cross member between holding arms) to provide more protection to the display element;

FIG. 7 shows a modification of the display element in which it is a roller;

FIG. 8 shows a modification of the display element in which it is a silhouette of a person celebrating life;

FIG. 9 is a modification of the display element and mount in which the display element is a self-righting floating element in a fluid-filled vessel;

FIG. 10 is a modification of the mount in that it is a spring for facilitating wobbling movement of the display device; and

FIG. 11 is a bar gun shown with the display device integrally formed, although it is to be understood that the display device could be attached to the bar gun and the function would be substantially identical.

### DETAILED DESCRIPTION OF PREFERRED EMBODIMENTS

Several aspects of the present technology are described in this specification, including a bar gun itself with integral display device, and a display device attachment for attachment to a bar gun. The different aspects, for convenience, may be described together, with differing preferred features which may be suitable for use on different and distinct aspects of the invention, but it is to be understood that each aspect is to be considered just as so—different and distinct aspects of the present invention. When describing the various aspects, like numerals denote like features (such as 10, 110, and so on).

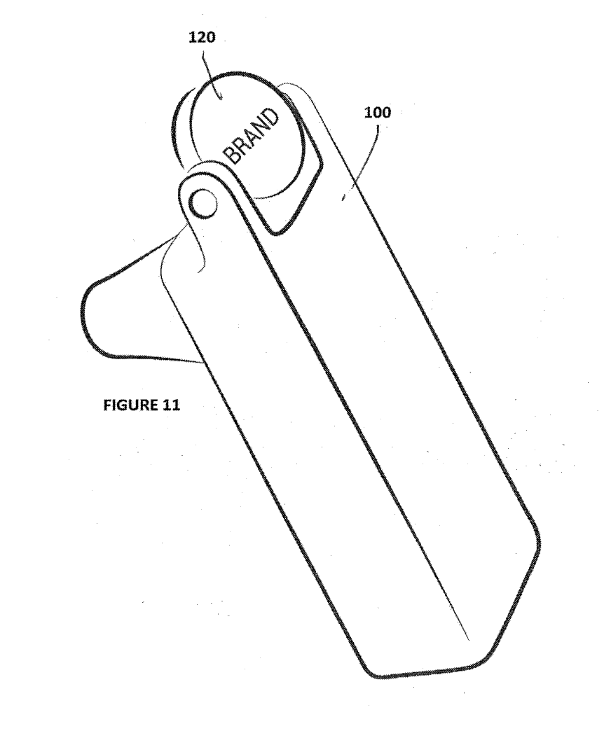

A bar gun is shown at 100 at FIG. 11, and mentioned as being a gun to which a display device 10 may be attached, but of course it is to be understood that the bar gun 100 shown has an integrated display device 110 and should be understood not as a known bar gun, but a bar gun improved by an integrated display device of the present invention.

Broad Aspects

Referring to the Figures there is shown a display device generally indicated at 10 in which a mount 12 is provided to mount a display element 20 on a bar gun (not shown). In one aspect of the present technology the display device 10 includes the mount 12 and the display element 20 operatively mounted on the mount 12 so as to move when the bar gun is handled to pour a drink.

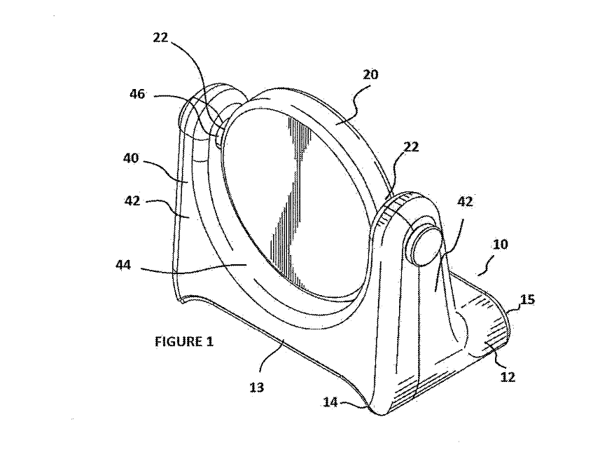

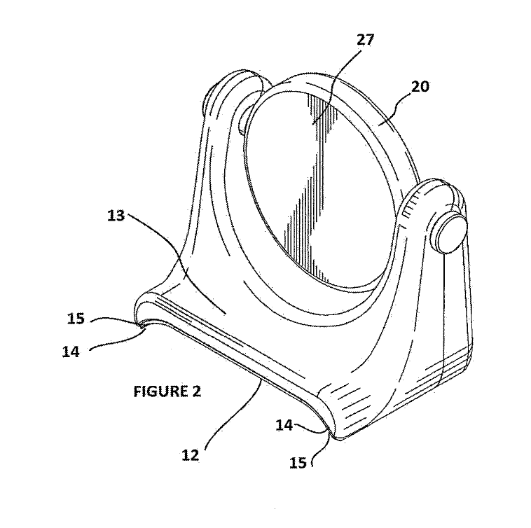

Advantageously, the display element 20 in at least FIGS. 1, 2, 8 and 9, is operatively mounted on the mount 12 or the bar gun 100 so as to be substantially self-righting; that is, to generally stay in substantially a vertical plane independent of an orientation of the bar gun, at least with respect to one axis. This is done so that when the bar gun is being moved around during a pour, and being held at an angled attitude to facilitate the pour into a glass, a brand message on the display element 20 can move around a little to catch the attention of a customer and subsequently be more easily viewed than a static message painted or adhered to the body or end of the bar gun 100.

In another aspect of the present technology, there is shown in FIG. 11 a bar gun 100 with an integral display device 110. The integral display device 110 comprises a display element 120 operatively mounted on the bar gun 100 so as to move when the bar gun 100 is handled to pour a drink.

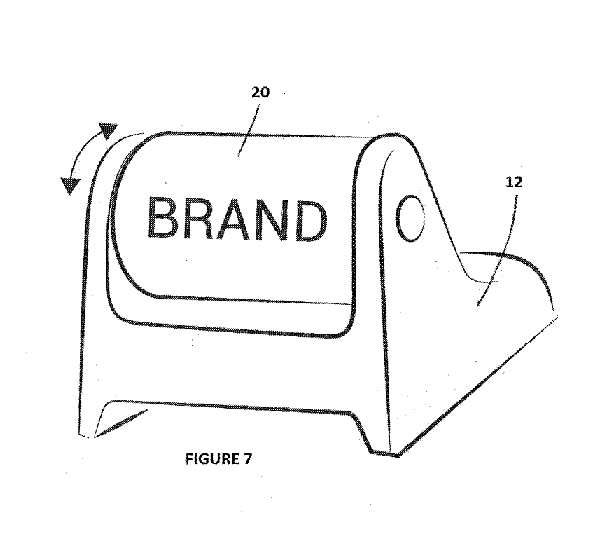

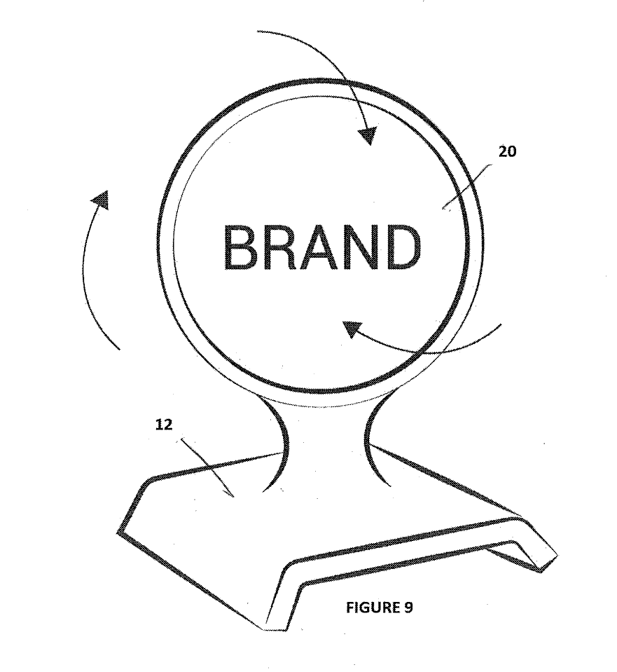

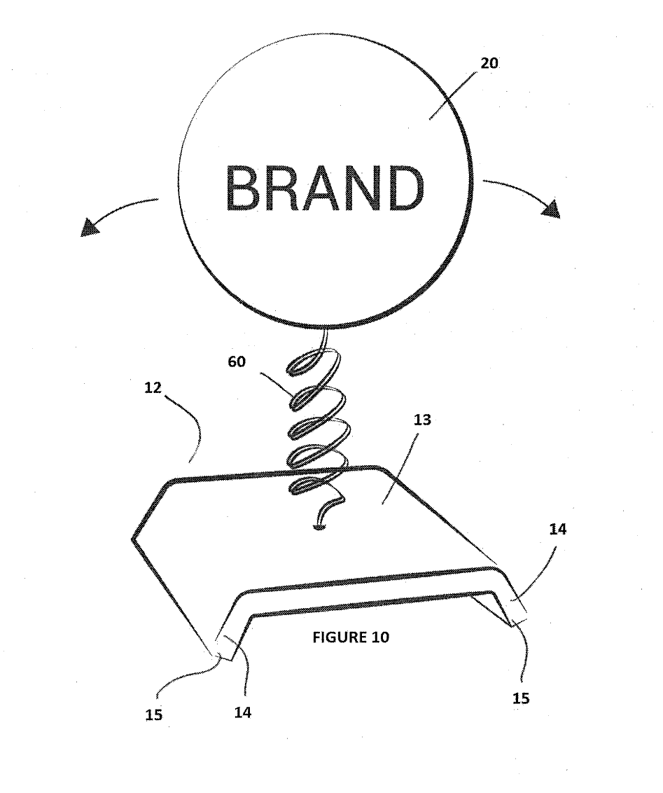

In some embodiments shown, the display element 20 is operatively mounted so as to spin (FIG. 7), swivel (FIG. 9) (about one or more axes), sway (FIG. 10), bounce, jiggle, slide, flip, or otherwise move. In these embodiments shown, the display element is, operatively mounted to move in response to the movement of the bar gun. This is due to the structural features described herein and is designed to catch the attention of the customer and keep the attention while they more easily read a message on the display element 20.

In some embodiments the display element is operatively mounted to move in response to the actuation of fluid flow in the bar gun. The response in some embodiments may be to moving drinking fluid which will flow into a customer's glass, or a response to a working fluid in a separate circuit, or an actuator circuit of hydraulic, working or electrical current. Different messages can then be made, using both sides of the display, or projectors from or onto the display element 20, or lenticular coatings on the display element 20.

The Mount 12

In embodiments shown in some of the Figures, the mount 12 is a base 13 for mounting onto the end of the bar gun (eg 100). The mount 12 includes locators 14 to locate the base 13 on a selected portion of the bar gun 100.

The locators may be in the form of catches 15, flanges or other undulations to facilitate location and grip on the bar gun 100.

There may be (not shown) grip regions such as knurling or sawtooth elements provided to increase the surface area of a mounting surface for increased hold.

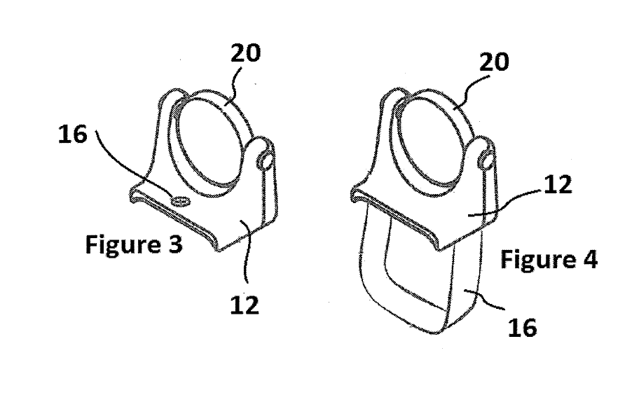

There is shown in the Figures, a fastener 16 to fasten the base 13 to a portion of the bar gun 100. The fastener 16 comprises double-sided adhesive tape but it may equally well include a screw (FIG. 3), adhesive fluid ie glue, one or more straps of adjustable length (FIG. 4), hook and loop fastener elements, or other suitable ties.

The Operative Connection Btw Display Element 20 and Mount

The operative connection between the mount 12 and the display element 20 provides one or more degrees of freedom of movement to the display element 20. The operative connection is a joint 30 which provides those levels of freedom, being of rotation or translation or both, for movement of the display element 20 in response to the handling and/or operation of the bar gun 100.

The mount 12 includes one or more holders 40 for holding the display element 20 in a position sufficiently spaced from the bar gun 100 to facilitate movement of the display element 20 in response to the handling or operation of the bar gun 100. Each holder 40 may be a clamp, structure, or some other suitable holding element.

The one or more holders comprise a plurality of arms 42 spaced apart from one another so as to provide a mounting zone 44 therebetween for the display element 20. The holders 40 include receivers 46 for receiving cooperating boss elements 22 therein. The receivers 46 are bores for receiving bosses in the form of stub axles extending from the display element 20 so that the display element 20 may rotate while mounted on the holder 40.

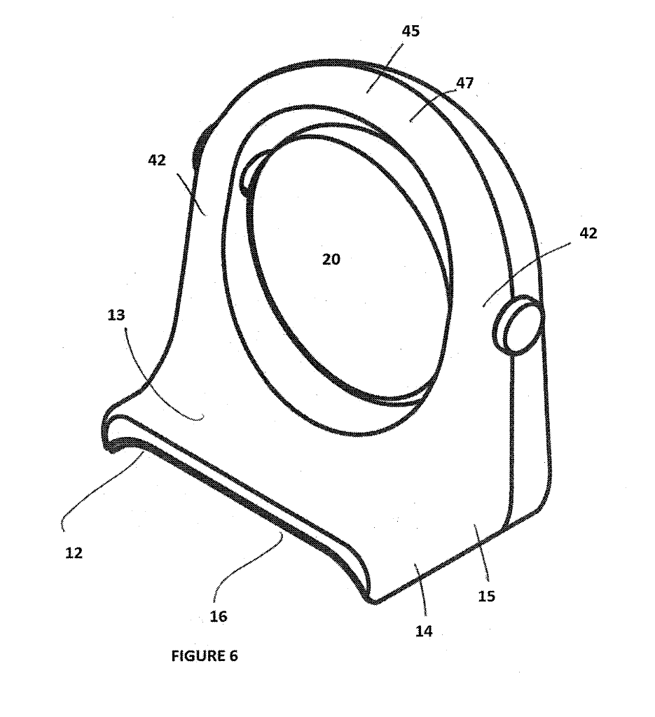

There is shown in FIG. 6 a mount 12 having a frame 45 which provides additional protection for the display element 20 includes arms 42 and a cross member 47 or cantilevered member acting to hang the display element 20 thereon. There may merely, without any other frame elements, be a cantilever or post 47 to hang the display element therefrom.

The mount 12, in FIG. 10, is shown to include a receiver on the base, to mount a bias element 60 in the form of a spring for mounting the display element 20 thereon so that it wobbles but seeks an equilibrium point, when the bar gun 100 is handled into different positions.

The Display Element 20

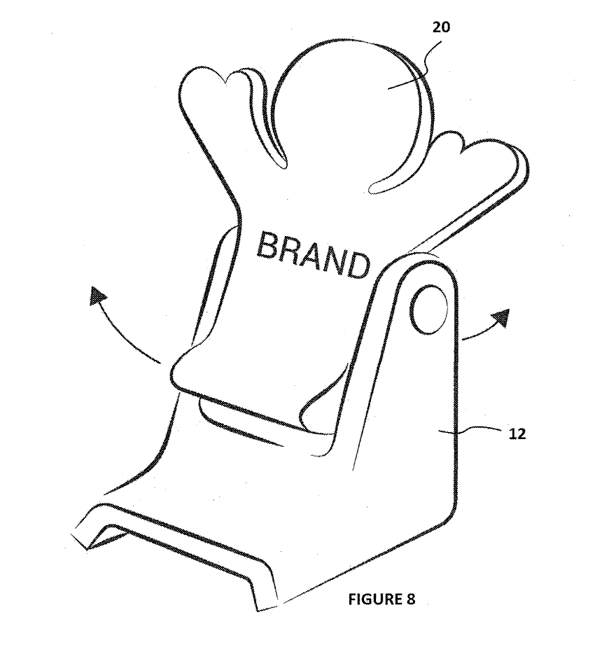

The display element 20 is a sign or board or like element on which a message may be printed. The sign may be in the form of a plate, disc, sphere, roller, or any suitable regular or irregular two-dimensional or three dimensional shape. For example the sign may be in the shape of an animal, animal head, stylised person (FIG. 8), octagon, dodecahedron, pentagon, hexagon, building, wrecking ball, or suitable element for indicating a trade mark, brand message or other indicator.

The sign may include a power source so as to power onboard elements. The power source may be a battery for lighting the display element. One of the onboard elements may be a motor for spinning or rocking the display element 20. The sign may include a lenticular element as a coating on one or more faces to provide a movable image when there is relative movement between a viewer and the sign.

The display element 20 may respond to a working fluid or a dispensed fluid from the bar gun itself in response to the actuation of the bar gun. The display element may also include a drive to respond to the working or dispensed fluids, and/or the main body of the sign itself may respond to the dispensed or working fluid to spin. The working fluid may be in a circuit to drive the drive or sign, or in some embodiments the dispensed fluid may exit a nozzle and impact the sign itself to drive the display element 20 around the stub axles 22.

The display element 20 may be a sign on which a message is printed (FIG. 8). The display element 20 may also be a powered screen 27. The screen may be an LED, LCD, e-Ink, or other suitable screen. There may be a light pipe which can receive an LED light so that the display element is illuminated.

The display element 20 may include programmable or preprogrammed computing processor elements such as processor, memory, input devices including accelerometers and other movement detectors, all connected by a bus, which are responsive to instructions so as to display different messages on the screen. The messages may depend on the movement of the handle and may be actuated in response to movement of the bar gun.

The display element 20 may be an unpowered screen for receiving projected images or messages from a projector mounted on the bar gun or mount. For example the screen may be a heads up display for receiving projected images.

There may be provided a projector on the bar gun 100 or mount 12 for projecting brand colours, messages or the like into an atomised mist or into a stream of dispensed fluid issuing from a nozzle of the bar gun.

A motor may be provided in the display element 20 or in the mount 12 or holder 40 for rotating or spinning or otherwise controlling the attitude of the display element so that it maintains a vertical or other angled orientation independent of the attitude of the bar gun 100.

The display element 20 may include one or more extensions 22 to extend into cooperating receivers 46 on the mount so as to swing or rotate on the mount 12.

The display element 20 is mounted on the holders 40 of the mount 12 so as to provide a damped or biased swinging movement wherein the display element seeks to hang in a substantially vertical position independent of the attitude of mount 12 or bar gun 100. To provide this swinging motion the one or more extensions 22 are upwardly offset from a centre of axis of the display element. This offset distance is so as to provide the biased movement. The effect is similar to that which would be provided by a weight in a lower portion of the display element, and indeed that feature of the weight is contemplated by the present inventors as being within the scope of this invention.

The stub axles 22 may have retainers in the form of flanges so that the display device is retained in the mounts 40, or so that they look cooler.

So it is to be understood that providing a swinging motion about a centre (of area) of the display element, coupled with an offset mass distribution (to the base of the display element), would be useful with this invention and covered by its scope.

It is the self-righting swinging feature which is particularly advantageous in this invention since the brand message is presented substantially vertically to the customer while a drink is being poured by the bartender. The swinging motion tends to catch the attention of the customer while all around is chaos and busyness. The other features of spinning, illumination, and so on are also advantageous for obtaining and keeping attention of the customer and directing their attention to the brand message on the display while in a crowded environment. In those embodiments, different effects can be achieved with the display which may include little machinery parts caused to move by the fluid flowing in either a separate circuit or the dispensing liquid circuit.

The display element 20 may be an element which self-rights or otherwise moves in a separate vessel of fluid. This is shown in FIG. 9.

In this specification, unless the context clearly indicates otherwise, the term “comprising” has the non-exclusive meaning of the word, in the sense of “including at least” rather than the exclusive meaning in the sense of “consisting only of”. The same applies with corresponding grammatical changes to other forms of the word such as “comprise”, “comprises” and so on.

It will be apparent that obvious variations or modifications may be made which are in accordance with the spirit of the invention and which are intended to be part of the invention, and any such obvious variations or modifications are therefore intended to be within the scope of the invention.

### EXAMPLES

In operation the display element 20 shown in the Figures self-rights independent of the attitude of the bar gun to which it is attached. This is generally because of the offset operative connection of the display 20 to the mount 12 in some embodiments, which results in more mass of the display element 20 being on a base side of the stub axles than the other side.

There may be a central pivot but a concentration of mass at a base end in other embodiments. In the embodiments shown in FIG. 8 the self-righting motion is because of a self-righting element floating in a sphere of water.

The colours may be varied, as may be the materials from which the display element 20 and the mount may be made. In one form the display element 20 is a disc with integral stub axle projections, each axle having retaining flanges. The disc may be steel, and may be indeed be any suitable material, such as polymer, moulded, cast, 3D printed, machined, or other suitable process. The axles may a different material from the disc but may be be comoulded therewith. The mount 12 may be polycarbonate or any suitable material, and can be seen to be split down a centre axis and joined down the mould line.

### INDUSTRIAL APPLICABILITY

The invention can be utilised in improving the effectiveness of advertising messaging in busy point of sale environments which may facilitate improved customer responsiveness to products and improves profitability.

1. A display device attachment configured to mount on a bar gun, the display device comprising:
a mount; and
a display element operatively mounted on the mount so as to move relative to the bar gun when the bar gun is handled to pour a drink.

2. The display device attachment in accordance with claim 1 wherein the display element is operatively mounted on the mount so as to spin, swivel, sway, bounce, slide, flip, or otherwise move relative to the bar gun.

3. The display device attachment in accordance with claim 1 wherein the display element is operatively mounted on the mount or the bar gun so as to remain in substantially a vertical plane independent of an attitude or orientation of the bar gun.

4. The display device attachment in accordance with claim 1 wherein the display element is operatively mounted to move relative to the bar gun in response to the actuation of fluid flow in the bar gun.

5. The display device attachment in accordance with claim 1 wherein the mount is a base for mounting onto an end region of the bar gun.

6. The display device attachment in accordance with claim 5 wherein the base includes locators to locate the mount on a selected portion of the bar gun, the locators being selected from the group consisting of catches and flanges to facilitate location and grip on the bar gun.

7. The display device attachment in accordance with claim 1 wherein there is provided a fastener to fasten the mount to the bar gun.

8. The display device attachment in accordance with claim 7 wherein the fastener is selected from the group consisting of double-sided adhesive tape, screw, glue, straps, hook and loop fastener elements or ties.

9. The display device attachment in accordance with claim 1 wherein the operative connection between the mount and the display element is a joint configured to provide rotation of the display element in response to the handling and/or operation of the bar gun.

10. The display device attachment in accordance with claim 1 wherein the mount includes a plurality of arms, each one spaced apart from another so as to provide a mounting zone therebetween for the display device.

11. The display device attachment in accordance with claim 1 wherein the display element is a sign selected from the group consisting of plate, disc, sphere, or roller.

12. The display device attachment in accordance with claim 11 wherein the mount includes a power source so as to provide powered movement or to light the sign.

13. The display device attachment in accordance with claim 11 wherein the sign includes a lenticular element to provide a movable image when there is relative movement between a viewer and the sign.

14. The display device attachment in accordance with claim 1 wherein the display element is a powered screen.

15. The display device attachment in accordance with claim 14 wherein the display element includes programmable or preprogrammed computing processor elements which are responsive to instructions so as to display different messages on the powered screen.

16. The display device attachment in accordance with claim 12 wherein a motor is provided, connected to the power supply, the motor being configured to rotate or control the attitude of the display element.

17. The display device attachment in accordance with claim 3 wherein the operative connection is offset from a centre of the display element so as to facilitate the display element remaining in the vertical position.

18. The display device attachment in accordance with claim 3 wherein the display element includes an offset weight configured to self-right the display element.

19. A bar gun with an integral display device, the display device comprising:
a display element operatively mounted on the bar gun so as to move when the bar gun is handled to pour a drink.

20. A bar gun with a display device in accordance with claim 1 attached thereto.
